(19) United States
(12) Patent Application Publication
(10) Pub. No.: US 2007/0088817 A1
(43) Pub. Date: Apr. 19, 2007

(54) Shared video service

(75) Inventor: Jiang Li, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/250,852

(22) Filed: Oct. 14, 2005

(51) Int. Cl. G06F 15/173

(52) U.S. Cl. 709/224

(57) ABSTRACT

The techniques and mechanisms described herein are directed to a shared video service that provides an interactive media environment. The shared video service includes a shared video service (SVS) management system, one or more SVS video servers, a number of client devices, and a number of video providers. The video providers transmit real-time video content and/or previously captured video content to one or more of the SVS video servers. The video content is catalogued and may be stored on one or more of the SVS video servers. A user operating a client device logs onto the SVS management system, locates desired media, and views the media. The SVS management system tracks the viewing time for each user and tracks the media being viewed. Users may be charged a monthly fee or be charged based on their viewing time. Providers may be allocated a portion of the revenue.

### BACKGROUND

The Internet has changed the way people obtain news, software, and other types of media. For example, in the past, news was typically obtained through newspaper publications, by radio, and/or television broadcasts. Software was typically obtained by purchasing computer media through a software retail store or by ordering over the telephone and receiving the software by mail.

Today, however, many websites disseminate various types of media through the Internet. For example, consumers may purchase and download software directly to their computer, view news articles on websites, listen to webcasts on the Internet, and obtain other types of media from the Internet. In order to find the various types of media, consumers typically perform a search on the Web for the media and then browse to one of the identified websites to obtain the desired news, software, or other media. This process, however, may be quite difficult and time consuming for some consumers. In addition, consumers are passive in this process and need to wait until reporters of news agencies have distributed the news stories. Therefore, it is desirable to have media more readily and easily available.

### SUMMARY

The techniques and mechanisms described herein are directed to a shared video service that provides an interactive media environment in which media is more readily and easily available. The shared video service includes a shared video service (SVS) management system, one or more SVS video servers, a number of video providers, and a number of client devices. The video providers transmit real-time video content and/or previously captured video content to one or more of the SVS video servers. The video content is catalogued and may be stored on one or more of the SVS video servers. A user operating one of the client devices may then logon onto the SVS management system, locate desired media, and view the media. The SVS management system tracks the viewing time for each user and tracks the media being viewed. Users may be charged a monthly fee or be charged based on their viewing time. The SVS management system may then allocate a portion of the revenue to the video providers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is an illustrative computing device that may be configured to implement the techniques and mechanisms described herein.

FIG. 2 is an illustrative shared video service environment for obtaining media content from a variety of computing devices shown in FIG. 1 and providing the media content to users via other computing devices.

FIG. 3 is a functional block diagram illustrating exemplary computer-readable components for implementing the functionality for the SVS management system shown in FIG. 2.

FIG. 4 is a functional block diagram illustrating exemplary computer-readable components for implementing the functionality for the shared video service servers shown in FIG. 2.

FIG. 5 is a functional block diagram illustrating exemplary computer-readable components for implementing the functionality for the video provider devices shown in FIG. 2.

FIG. 6 is a functional block diagram illustrating exemplary computer-readable component for implementing the functionality for the user client devices shown in FIG. 2.

### DETAILED DESCRIPTION

Briefly, the present shared video service provides mechanisms and techniques for sharing video. In overview, computing devices, such as camera phones, personal digital assistants, camcorders, and the like, may transmit breaking news stories, events, and other video content to the shared video servers. This video content is then cataloged so that users can easily locate and obtain the video for viewing. These and other advantages will become clear after reading the following detailed description.

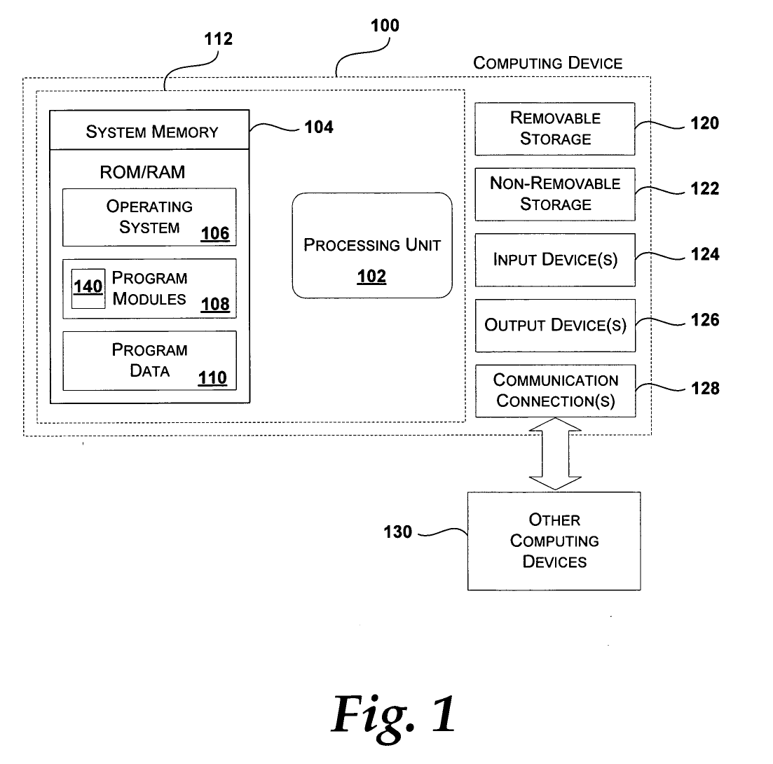

The various embodiments of the present shared video service may be implemented using different types of computing devices, such as portable computing devices, desktop computing devices, servers, and the like. With reference to FIG. 1, one exemplary computing device for implementing the shared video service includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 106, one or more program modules 108, and may include program data 110. The program modules 108 may include one or more components 140 for implementing portions of the present shared video service functionality. This basic configuration is illustrated in FIG. 1 by those components within dashed line 112.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 120 and non-removable storage 122. Computer storage media may include volatile and nonvolatile, removable and non-removable media implemented in any method or technology for storage of information, such as computer-readable instructions, data structures, program modules, or other data. System memory 104, removable storage 120 and non-removable storage 122 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 124 such as keyboard, mouse, pen, voice input device, touch input device, etc. Output device(s) 126 such as a display, speakers, printer, etc. may also be included. These devices are well known in the art and need not be discussed at length here.

Computing device 100 may also contain communication connections 128 that allow the device to communicate with other computing devices 130, such as over a network. Communication connection(s) 128 is one example of communication media. Communication media may typically be embodied by computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both storage media and communication media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

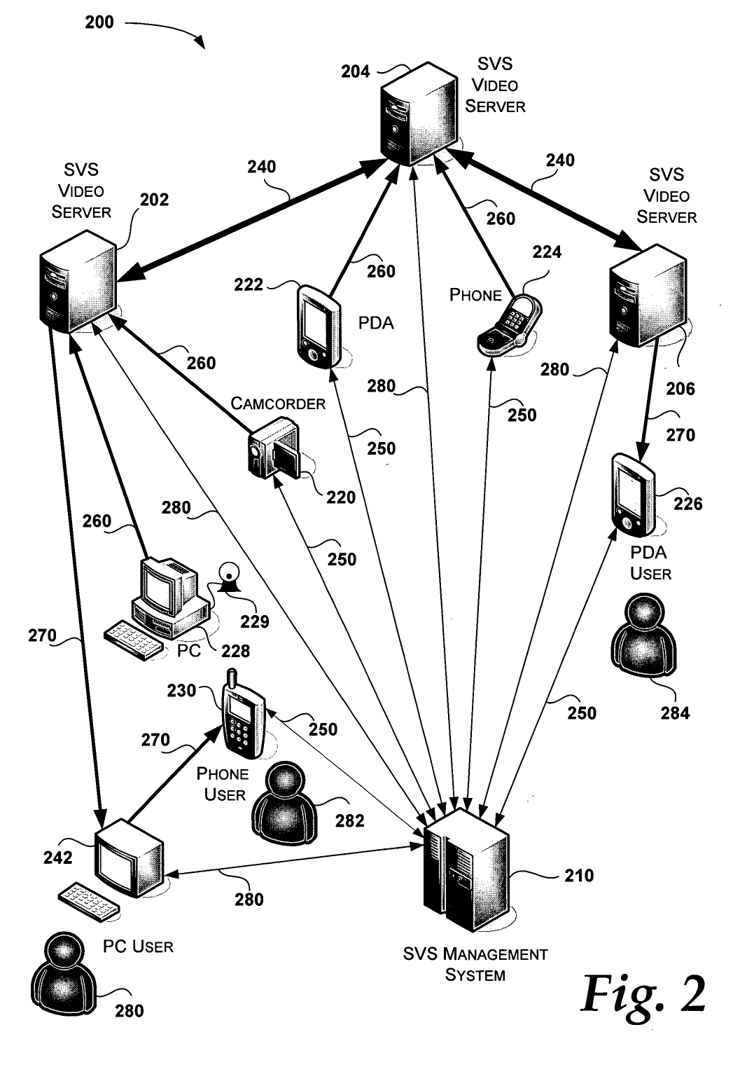

FIG. 2 is an illustrative shared video service environment 200 for sharing video media. The shared video service environment 200 includes several shared video service (SVS) video servers (e.g., SVS video servers 202-206), a SVS management system 210, and one or more provider devices (e.g., camcorder 220, personal digital assistant (PDA) 222, phone 224, and PC 228 with an optional webcam 229). In overview, the video providers logon onto the SVS management system and then transmit real-time video content and/or previously captured video content to one or more of the SVS video servers as decided by the SVS management system. Video content includes, but is not limited to, movies, television, broadcasts, webcasts, video, and pictures. The SVS management system catalogs the video content and remembers where the video content is stored. A user (e.g., user 282) operating a client device (e.g., phone 230) logs onto the SVS management system, locates desired media, and views the media.

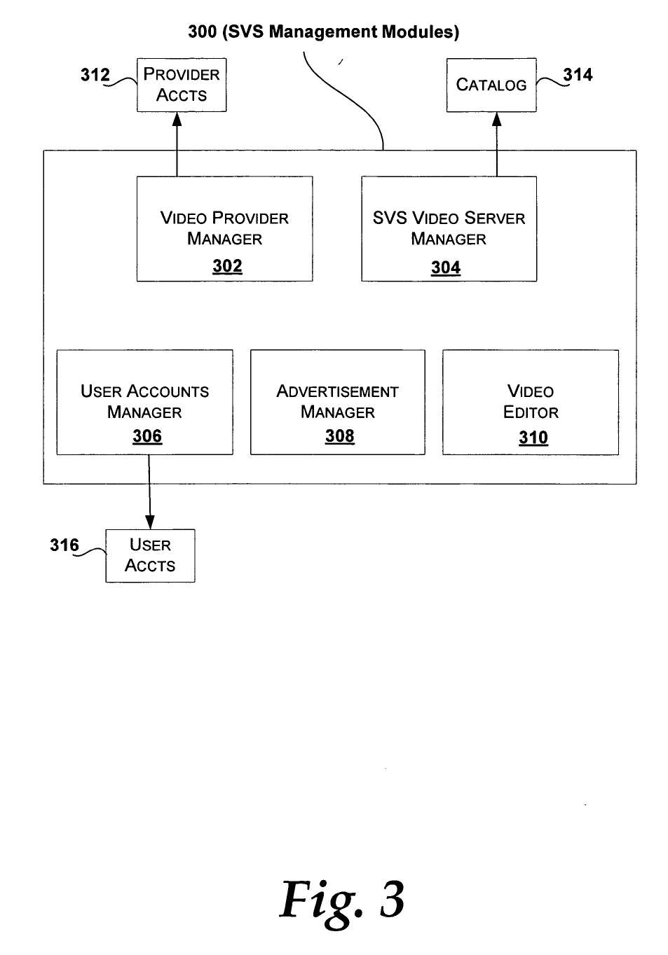

SVS video servers, SVS management system, provider devices, and user devices are illustrative computing devices, such as computing device 100 shown in FIG. 1. Each computing device has a set of computer-readable modules 140 configured to perform a portion of the functionality to support the shared video service. The set of computer-readable modules 140 determines the functionality of the computing device. One computing device may have multiple sets of computer-readable modules. This allows the computing device to function in different capacities within the shared video service environment. For example, computer 242 functions as a user device for PC user 280 and as a SVS Video Server for relaying video content to the phone device 230. Each set of computer-readable modules is described below in conjunction with FIGS. 3-6 for the SVS management system, video servers, provider devices, and user devices, respectively.

While SVS management system 210 is illustrated as one computer, the SVS management system 210 may be any number of computers operating in cooperation to provide the SVS management functionality for the shared video service. Provider devices may include, but are not limited to, camcorders, webcams, PDAs, phone cameras, televisions networks, news agencies, and movie producers. In addition, provider devices may be integrated with the global positioning system (GPS) so that the location of the provider device may be automatically determined. User devices may include, but are not limited to phones, PDAs, personal computers, game systems, television, and the like.

The SVS video servers include dedicated video storage for storing videos for later replay. The video storage incorporates video storage technology capable of storing a massive number of videos and of providing fast access to the videos. The videos that are received by the SVS video servers may be of various formats and from various types of devices. The SVS video servers also include video processing, compression, and transcoding techniques that are commonly available.

The shared video service includes several connections 240, 250, 260, 270, and 280 between the different computing devices. These connections may be wired networks, wireless networks, or a combination of both. The wireless network may support 802.11, GSM, GPRS, CDMA, and the like. The connection may be via the Internet or an Intranet. Connection 240 allows SVS video servers to communicate between each other. Connection 250 allows the SVS management system to communicate with the provider devices and the user devices. Connection 260 allows provider devices to communicate with SVS video servers. Provider devices transmit their real-time video content or captured video content to SVS video servers via connection 260. Connection 270 allows SVS video servers to communicate with user devices. SVS video servers transmit the selected video to user devices via connection 270. Connection 280 allows the SVS video servers and the SVS management system to communicate with each other. For example, the SVS management system may transmit control data to the SVS video servers via connection 280. The control data may specify a specific SVS video server for storing a specific video or for transmitting the video to one or more client devices.

In operation, the shared video service environment allows video content to be easily shared. The shared video service environment may be used in a variety of different scenarios. Some example scenarios are described now and more are described later through-out detailed description. In one scenario, a by-stander with a camera phone. (e.g., phone 224) may logon onto SVS management system and transmit video of a breaking news event to SVS video server 204. The by-stander may specify a category in the SVS management system for the transmitted video or a category may be assigned to the transmitted video. Users operating other computing devices (e.g., PC 242) may then select the transmitted video via connection 270 with the SVS video server 202. As shown, PC 242 operates as a user client device and as a SVS video server when needed. Therefore, PC 242 may have both a connection 240 (not shown) with a SVS video server and a connection 270 with the same or other SVS video server. The SVS management system then determines which SVS video server should relay the video to PC 242 and instructs that SVS video server 202 relay the video to PC 242. The SVS video server 202 then relays the video to PC 242 via connection 270 (not shown). In another scenario, a camera (e.g., camcorder 220, a webcam attached to a PC, or a webcam with network function) may transmit real-time video of an intersection of two roads to a SVS video server. Drivers who use the intersection may then logon to the SVS management system and select this real-time video to view the traffic situations using a client device, such as via PDA 226.

As shown, FIG. 2 illustrates a small number of SVS video servers, provider devices, and client devices. In operation, there will be numerous SVS video servers throughout the world so that provider devices from all over may connect to the shared video service environment. The SVS management system, SVS video servers, provider devices, and client devices will each incorporate a set of computer-readable components that will provide a portion of the shared video service functionality. Some computing devices may have multiple sets of computer-readable components so that one computing device may function as a provider device and a client device, a SVS video server and a client device, and the like. FIGS. 3-6 describe the different sets of computer-readable components. One skilled in the art will appreciate that the functionality provided by the modules within each set may be arranged in various ways without departing from the present shared video service.

FIG. 3 is a functional block diagram illustrating exemplary computer-readable components 140 (hereinafter referred to as SVS management modules 300) for implementing functionality for the SVS management system shown in FIG. 2. The SVS management modules 300 include a video provider manager 302, a SVS video server manager 304, and a user accounts manager 306. The SVS management modules 300 may also optionally include an advertisement manager 308 and/or a video editor 310. Each of these modules is now described in greater detail.

The video provider manager 302 is configured to manage provider accounts 312 of video providers. The video provider manager 302 ensures that each provider account is unique when it is established. Once the provider account is established, the video provider manager authenticates each video provider's logon to verify that the video provider is associated with the requested provider account. The video provider manager tracks the viewing time of the videos provided by each provider account and determines the amount to pay each provider account. The amount of revenue that is shared with the video provider may be based on the amount of viewing time of the video content provided by the provider.

In addition, the video provider manager may rate video content according to its access frequency, novelty, and other factors. For example, the video provider manager may create a list of the most viewed video content. The ratings for the video content may then affect the placement of the video content when displayed by the user-interface on the user client device. As the video content rankings change, the position of the video content on the user-interface may also change. Therefore, videos of emergent or important events may become more visible to subscribers as the video content becomes accessed more frequently.

The SVS video server manager 308 is configured to establish proper categories 314 for the video content. The video content may be cataloged in one or more category. The categories may be arranged in a hierarchical structure. In addition, the SVS video server manager determines which SVS video server or servers should store the new content. The SVS video server manager 308 may enforce an agreement with each of the SVS video servers for the videos stored on the servers based on different factors, such as based on traffic for specific videos and user's subscriptions.

The user accounts manager 304 is configured to manage user accounts 316. The user accounts manager authenticates and accepts users' signing onto the SVS management system. Once the user is signed-on, the user accounts manager is configured to respond to the selection of a video by the user and to issue commands to the SVS video servers to stream the selected video to the requesting user. The user accounts manager 304 is also configured to track a user's viewing time of videos.

The user accounts manager is also configured to calculate the fee charged for each of the user accounts. The user accounts manager tracks the viewing time and the media being viewed. Users may be charged a monthly fee or may be charged based on their viewing time. In another embodiment, the user accounts manager may track the video content that is viewed that has had advertisements associated with the video content. The associated advertisements may appear inserted within the video content, beside the video content, or in other arrangements. Briefly, described below in conjunction with advertisement manager 308, video content may have advertisements selectively placed within the video content or beside the display area of the video content. The user accounts manager may then refrain from charging user accounts for viewing video content with associated advertisements. Instead, the shared video service charges the advertisers for viewing time of the video content with the advertisements. Using the information tracked by the provider accounts manager and the user accounts manager, the SVS management system may then allocate the revenue among the video providers and other participants in the shared video service.

Advertisement manager 308 is configured to selectively associate advertisements with the video when the video is transmitted to users. If advertisements are inserted within the video, the advertisement manager may inform the user accounts manager so that the user accounts manager does not charge a fee to users for viewing videos with advertisements. For example, the viewing time for videos with advertisements may not be added to user's viewing time of videos. This allows consumers flexibility in determining how best they want to view video and whether they wish to forgo seeing advertisements to save money or whether they wish to pay for viewing videos without advertisements.

Video editor 310 is configured to edit video content. The video content may be edited by the provider who originally transmitted the video content to the shared video service.

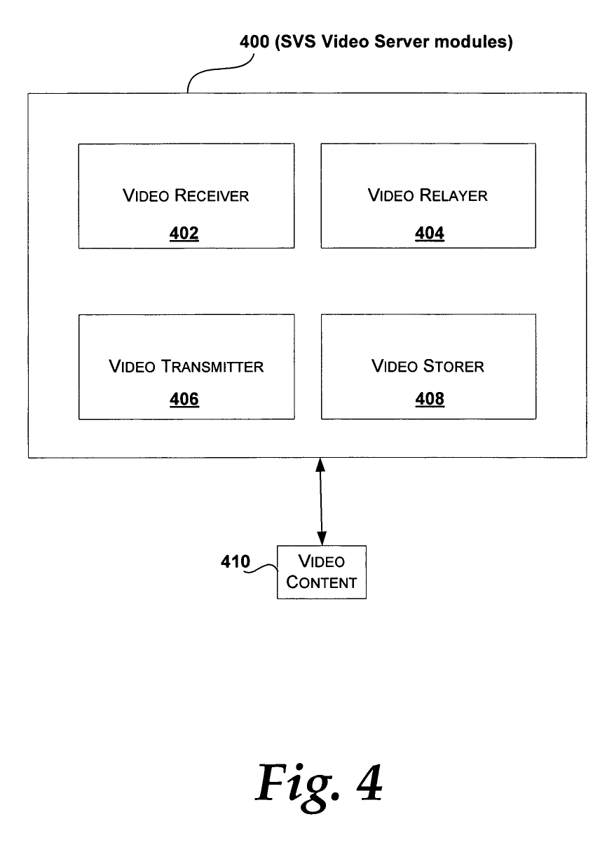

FIG. 4 is a functional block diagram illustrating exemplary computer-readable components 140 (hereinafter referred to as SVS video server modules 400) for implementing functionality for the SVS video server. The SVS video server modules 400 include a video receiver 402, a video relayer 404, a video transmitter 406, and a video storer 408.

Video receiver 402 is configured to receive video content 410 from one or more video provider. The optional storage of the received video is handled by the video storer 408. The video content includes a bit stream or video file. If the video provider has specified a category, the SVS management system links the video content to a suitable location within the specified category in the SVS management system. However, if the video provider has not specified a category, the SVS management system determines a category and links the bit stream or video file with that category. The video storer 408 is configured to store the bit stream or video file for later playback. The video storer 408 is also configured to provide the bit stream to the video relayer 404 for storing on another SVS video server.

The video relayer 404 is configured to transmit the bit stream to another SVS video server or to a user. Video relayer 404 is also configured to relay one of the captured video files to another SVS video server or a user.

The video transmitter 406 is configured to transmit video content 410 to a user when requested. The video content that is transmitted may be a real-time bit stream or may be a video file. The real-time bit stream may be video content that is currently being received by the video receiver 402 or may be video content that is being relayed from another SVS video server via the video relayer 404. The video file may be a captured video file that is stored on the SVS video server or may be a video file relayed from another SVS video server. Because a large amount of video content will be transmitted from the SVS video servers to a large number of subscribers, direct server to client streaming may not be sufficient. Thus, SVS video servers may relay each other's videos to better serve users located throughout the world. Some powerful SVS clients (e.g., PC client 242 shown in FIG. 2) may also take part in the relay task. This relay task implements a strategy associated with application-level multicast technology. The application-level multicast technology allows video content to be directly sent to the target or relayed via several clients.

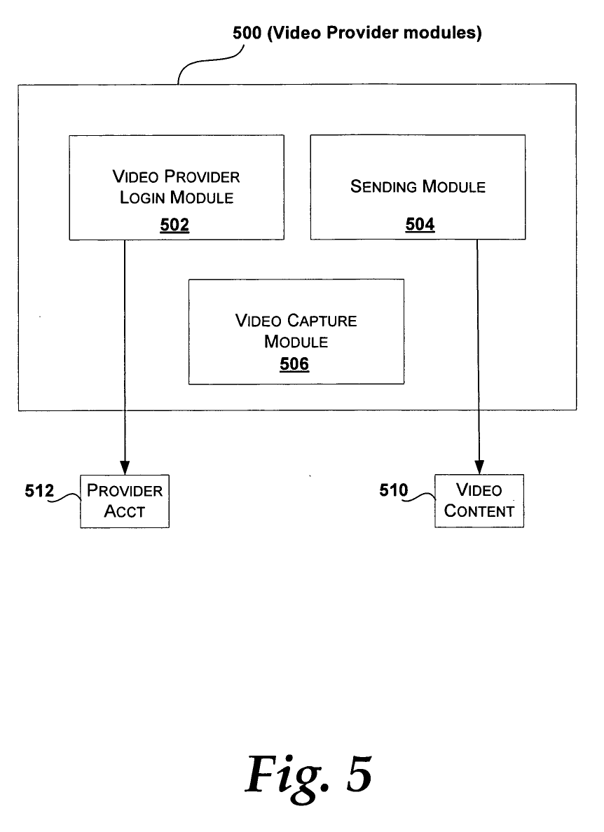

FIG. 5 is a functional block diagram illustrating exemplary computer-readable components 140 (hereinafter referred to as video provider modules 500) for implementing functionality for the video provider shown in FIG. 2. The video provider modules 500 include a video provider login module 502, a sending module 504, and a video capture module 506.

The video provider login module 502 is configured to establish and access a provider account 512 with the shared video service. The video provider login module provides an interface for a user to establish the provider account with the shared video service. After the provider account is established, the provider may log onto the account using different video provider devices. In another embodiment, each video provider device is associated with a specific provider account.

The sending module 504 is configured to stream video content 510 to the SVS video server to which the video provider device is connected. The sending module may stream video content that is being captured real-time. Thus, the sending module sends the video content in time sequence. In addition, the sending module may send video content that has been captured and edited. In this instance, the video content is not in time sequence and may not be played until the captured video file has been received. The sending module 504 provides a user-interface to the user for selecting the desired video content from within one of the categories within the shared video service. The sending module 504 may remember the location within a category so that it can resume streaming or sending from that location.

The capture module 506 is used to capture the video content. The capture module 506 saves the video content on the provider device. This captured video content may then later be sent or simultaneously sent to the SVS video server via the sending module 504.

The video content that is sent by the video provider is associated with the video provider so that the video provider can be paid for contributing the video content. Thus, not only program producers, television stations, and cable television operators earn money from viewers watching television, but the present shared video service also allows providers of any video content sent to the shared video service to earn money.

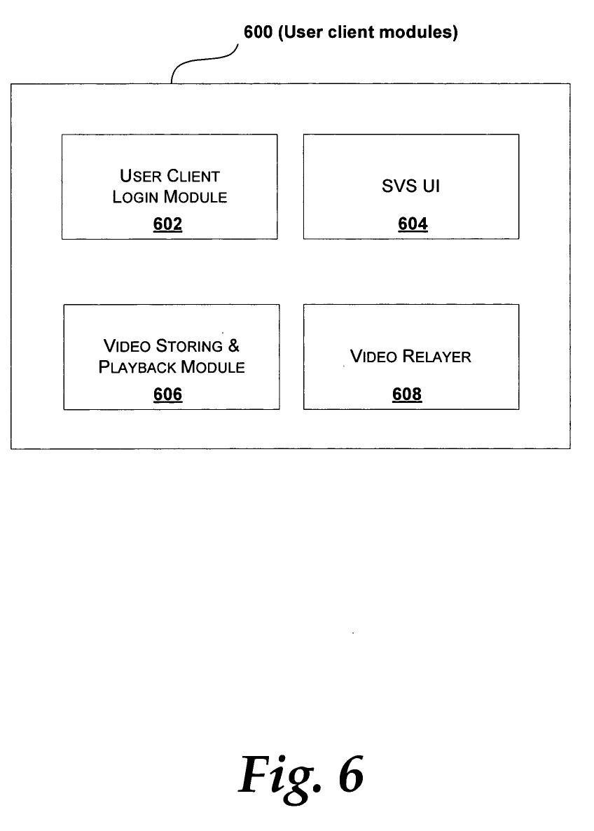

FIG. 6 is a functional block diagram illustrating exemplary computer-readable component (hereinafter referred to as user client modules 600) for implementing functionality for the user client device shown in FIG. 2. The user client modules 600 include a user client login module 602 and a shared video service user-interface 604. The user client modules 600 may optionally include a video storing and playback module 606 and/or a video relayer 608.

The user client login module 602 is configured to create and access a user account. The user may use one user account for multiple client devices. As mentioned above, the shared video service tracks the viewing of video content by each user account and may charge the user accordingly.

The shared video service user-interface 604 is configured to provide an interface for selecting video content available on the shared video service. In one embodiment, the shared video service user-interface provides an operating interface similar to television and/or radio, without complicated web browsing. Thus, video content is more easily located. The shared video service user-interface may display thumbnails of the video content available in each category. The categories may include geographic locations, encyclopedia, interest groups, ratings, favorites, and the like. The thumbnails may be of updating videos or video files. The updating video represents videos that are being captured and streaming from the provider. In addition, updating videos include videos that have been captured or edited which are streaming from the providers.

The user-interface module allows browsing, selecting, and watching of videos. For example, in a geographic based category, users can quickly locate a desired area and watch videos being captured in that area. In addition, a map of the area may be shifted left/right to view neighboring locations. In a television or movie category, users can quickly select a television program or a movie from hundreds of thousands of videos. The user-interface provides a hierarchical structure and the selection-based interface does not require any typing.

Once the user has selected the video content, the selected video content is sent to the user device by an SVS video server. The SVS video server may have the video content stored or it may be currently receiving the video content from a provider device. The video content may also be relayed through other SVS video servers or client devices functioning as a SVS video server. The start and stop watching time of the video content is recorded in the account of the user in the shared video service. The time is also recorded in the account of the video provider.

The video storing and playback module is configured to store the retrieved video content for playing at a later time. The video relayer is configured to relay videos received from SVS video servers or client devices to other client devices or other SVS video servers. As mentioned above, the user client modules and the video provider client modules may reside in the same computing device.

As described above, the shared video service environment provides a new service and business model for sharing videos. The shared video service environment provides a video capture, editing, transmission, and consumption cycle for viewing video. The shared service environment provides an easy to use operating interface that is more convenient than web browsing. In addition, the shared video service environment provides a mechanism for charging users in a variety of ways. Some users may be charged a monthly fee. Other users may be charged based on their viewing time, the content that is viewed, or the like. The viewing fee may be covered by the advertisement sponsor if an advertisement has been associated with the video content. This allows consumers greater flexibility and the ability to select their viewing preferences. The shared service environment also provides a mechanism for sharing the earnings of the service with the video providers who provide the video content.

Because video provider modules may be configured in video provider devices all throughout the world, the video content available in the shared video service environment does not only have a local range, but also has a world wide range. In addition, the video provider device may be one of many different types of computing devices. Thus, the shared video environment can contain all the features and content provided by current television and video on demand systems, but also content provided by individuals. Thus, consumers are not limited to a certain number of channels as they are using television and are not limited to a certain number of movies and programs as they are using video on demand. As described above, video providers may provide content, such as TV channels, movies, news, captured videos, and capturing videos all over the world. Thus, the video content offered to consumers using the shared video service is quite varied.

While some example scenarios have been given through out the above detailed description, those skilled in the art will appreciate that the shared video service may be implemented for many other scenarios. Some of these other scenarios include, but are not limited to, real-time travel adventures, multiparty video conference, political announcements or opinions, scenic viewpoint monitors, war time applications, and the like.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention. For example, the functionality of the SVS management system, SVS video servers, provider devices, and client devices have been separated into various modules in order to aid in describing the functionality. However, those skilled in the art will appreciate that the various modules may be combined and/or further separated into other modules without departing from the scope of the claimed invention.

What is claimed is:

1. At least one computer-readable medium storing at least one computer-executable module executable by a processor in a computing device, the at least one computer-executable module comprising:
a video provider manager configured to manage a video provider account associated with a video provider device that provides video content to a shared video service;
a user accounts manager configured to manage a user account associated with a subscriber that requests video content from the shared video service, the user accounts manager tracks viewing time of the video content requested by the subscriber; and
a SVS video server manager configured to determine a catalog into which the video content is associated and to determine a path by which the subscriber receives the video content when requested.

2. The computer-readable medium of claim 1, wherein the video provider manager is further configured to pay the video provider based on subscriber's viewing time of the video content provided by the video provider.

3. The computer-readable medium of claim 1, wherein the user accounts manager is further configured to charge the subscriber based on the subscriber's viewing time of the video content.

4. The computer-readable medium of claim 1, wherein the user accounts manager is further configured to charge the subscriber a fixed monthly fee.

5. The computer-readable medium of claim 1, further comprising an advertisement manager configured to associate one or more advertisements with the video content transmitted to the subscriber operating a client device.

6. The computer-readable medium of claim 5, wherein the user accounts manager is further configured to track video content received by the subscriber and to charge the subscriber accordingly, video content with advertisements that are viewed by the subscriber are not included in the charge to the subscriber.

7. The computer-readable medium of claim 1, wherein the catalog comprises a hierarchical structure.

8. At least one computer-readable medium storing at least one computer-executable module executable by a processor in a computing device, the at least one computer-executable module comprising:
a video provider login configured to establish and access a provider account with a shared video service;
a sending module configured to send video content to a SVS video server that transmits the video content to a subscriber requesting the video content, the sending module having a user interface for specifying a category for the video content within the shared video service, the video content being associated with the provider account, the provider account being paid revenue based on the video content provided by the provider account.

9. The computer-readable medium of claim 8, wherein the at least one computer-executable module resides on a video provider device, the video provider device comprising a camera phone, camcorder, personal computer, laptop computer, or personal digital assistant.

10. The computer-readable medium of claim 9, wherein the provider account is associated with one video provider device.

11. The computer-readable medium of claim 9, wherein the provider account is associated with a plurality of video provider devices.

12. The computer-readable medium of claim 8, wherein the video content is transmitted in time sequence.

13. The computer-readable medium of claim 8, wherein the video content is not transmitted in time sequence.

14. The computer-readable medium of claim 8, further comprising a user client login for creating and accessing a user account, the user account being associated with the subscriber.

15. The computer-readable medium of claim 14, further comprising a shared video service user-interface for selecting the video content sent to the subscriber.

16. The computer-readable medium of claim 14, further comprising a storage and playback module for storing the video content received from the SVS video server and for playing the video content at a later time.

17. At least one computer-readable medium storing at least one computer-executable module executable by a processor in a computing device, the at least one computer-executable module comprising:
a video receiver configured to receive video content transmitted from a video provider device associated with a video provider account;
a video transmitter configured to transmit the video content to a subscriber requesting the video content wherein the video provider account is paid revenue based on the subscriber's request for the video content.

18. The computer-readable medium of claim 17, wherein the video receiver is further configured to respond to control data sent from a SVS management system that instructs in which catalog to store the video content.

19. The computer-readable medium of claim 17, further comprising a video relayer configured to relay the video content to another SVS server for transmitting to the subscriber.

20. The computer-readable medium of claim 17, further comprising a video storer for storing the video content.
